(19) United States
(12) Patent Application Publication
(10) Pub. No.: US 2012/0155655 A1
(43) Pub. Date: Jun. 21, 2012

(54) MUSIC DETECTION BASED ON PAUSE ANALYSIS

(75) Inventors: Denis Vladimirovich Parkhomenko, Moscow (RU); Pavel Aleksandrovich Aliseychik, Moscow (RU); Dmitry Nikolaevich Babin, Moscow (RU); Alexander Markovic, Media, PA (US); Ivan Leonidovich Mazurenko, Khimki (RU)

(73) Assignee: LSI Corporation, Milpitas, CA (US)

(21) Appl. No.: 13/205,856

(22) Filed: Aug. 9, 2011

(30) Foreign Application Priority Data
Dec. 20, 2010 (RU) 2010152224

(51) Int. Cl. H04R 29/00

(52) U.S. Cl. 381/56

(57) ABSTRACT

In one embodiment, a pause-based music detection (MD) module detects music by analyzing pauses in a received audio signal. The energy of each frame of the signal is compared to an energy threshold to determine whether the frame corresponds to background noise only (i.e., a pause) or sound such as speech or music. A window having a number of frames is analyzed to determine whether there is a pause within the window. If no pauses are detected in the window, then the current frame is presumed to correspond to music. If a pause is detected, then the current frame is presumed to correspond to speech. In another embodiment, the pause-based MD module output is applied to Boolean “OR” logic along with a tone-based MD module output to generate a final MD decision. The tone-based MD module detects music by analyzing tones in the signal using any suitable tone-based MD algorithm.

### CROSS-REFERENCE TO RELATED APPLICATIONS

The subject matter of this application is related to Russian patent application no. ______ filed as Attorney Docket number L09-0669RU1 on the same day as this application, the teachings of which are incorporated herein by reference in their entirety.

### BACKGROUND OF THE INVENTION

1. Field of the Invention

The present invention relates to signal processing, and, more specifically but not exclusively, to techniques for detecting music in an acoustical signal.

2. Description of the Related Art

Music detection techniques that differentiate music from other sounds such as speech and noise are used in a number of different applications. For example, music detection is used in sound encoding and decoding systems to select between two or more different encoding schemes based on the presence or absence of music. Signals containing speech, without music, may be encoded at lower bit rates (e.g., 8 kb/s) to minimize bandwidth without sacrificing quality of the signal. Signals containing music, on the other hand, typically require higher bit rates (e.g., >8 kb/s) to achieve the same level of quality as that of signals containing speech without music. To minimize bandwidth when speech is present without music, the encoding system may be selectively configured to encode the signal at a lower bit rate. When music is detected, the encoding system may be selectively configured to encode the signal at a higher bit rate to achieve a satisfactory level of quality. Further, in some implementations, the encoding system may be selectively configured to switch between two or more different encoding algorithms based on the presence or absence of music. A discussion of the use of music detection in sound encoding systems may be found, for example, in U.S. Pat. No. 6,697,776, the teachings of which are incorporated herein by reference in their entirety.

As another example, music detection techniques may be used in video handling and storage applications. A discussion of the use of music detection in video handling and storage applications may be found, for example, in Minami, et al., “Video Handling with Music and Speech Detection,” IEEE Multimedia, Vol. 5, Issue 3, pgs. 17-25, July-September 1998, the teachings of which are incorporated herein by reference in their entirety.

As yet another example, music detection techniques may be used in public switched telephone networks (PSTNs) to prevent echo cancellers from corrupting music signals. When a consumer speaks from a far end of the network, the speech may be reflected from a line hybrid at the near end, and an output signal containing echo may be returned from the near end of the network to the far end. Typically, the echo canceller will model the echo and cancel the echo by subtracting the modeled echo from the output signal.

If the consumer is speaking at the far end of the network while music-on-hold is playing from the near end of the network, then the echo and music are mixed producing a mixed output signal. However, rather than cancelling the echo, in some cases, the non-linear processing module of the echo canceller suppresses the echo by clipping the mixed output signal and replaces fragments of the mixed output signal with comfort noise. As a result of this improper and unexpected echo canceller operation, instead of music, the consumer may hear intervals of silence and noise while the consumer is speaking into the handset. In such a case, the consumer may assume that the line is broken and terminate the call.

To prevent this scenario from occurring, music detection techniques may be used to detect when music is present, and, when music is present, the non-linear processing module of the echo canceller may be switched off. As a result, echo will remain in the mixed output signal; however, the existence of echo will typically sound more natural than the clipped mixed output signal. A discussion of the use of music detection techniques in PSTN applications may be found, for example, in Avi Perry, “Fundamentals of Voice-Quality Engineering in Wireless Networks,” Cambridge University Press, 2006, the teachings of which are incorporated herein by reference in their entirety.

A number of different music detection techniques currently exist. In general, the existing techniques analyze tones in the received signal to determine whether or not music is present. Most, if not all, of these tone-based music detection techniques may be separated into two basic categories: (i) stochastic model-based techniques and (ii) deterministic model-based techniques. A discussion of stochastic model-based techniques may be found in, for example, Compure Company, “Music and Speech Detection System Based on Hidden Markov Models and Gaussian Mixture Models,” a Public White Paper, http://www.compure.com, the teachings of which are incorporated herein by reference in their entirety. A discussion of deterministic model-based techniques may be found, for example, in U.S. Pat. No. 7,130,795, the teachings of which are incorporated herein by reference in their entirety.

Stochastic model-based techniques, which include Hidden Markov models, Gaussian mixture models, and Bayesian rules, are relatively computationally complex, and as a result, are difficult to use in real-time applications like PSTN applications. Deterministic model-based techniques, which include threshold methods, are less computationally complex than stochastic model-based techniques, but typically have higher detection error rates. Music detection techniques are needed that are (i) not as computationally complex as Stochastic model-based techniques, (ii) more accurate than deterministic model-based techniques, and (iii) capable of being used in real-time low-latency processing applications such as PSTN applications.

### SUMMARY OF THE INVENTION

In one embodiment, the present invention is a processor-implemented method for processing audio signals to determine whether or not the audio signals correspond to music. According to the method, the processor characterizes whether pauses exist in a received audio signal. Further, the processor makes a pause-based determination of whether or not the received audio signal corresponds to music based on the characterization of whether pauses exist in the received audio signal.

In another embodiment, the present invention is an apparatus comprising a processor for processing audio signals to determine whether or not the audio signals correspond to music. The processor is adapted to characterize whether pauses exist in a received audio signal. Further, the processor is adapted to make a pause-based determination of whether or not the received audio signal corresponds to music based on the characterization of whether pauses exist in the received audio signal.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of a near end of a public switched telephone network (PSTN) according to one embodiment of the present invention;

FIG. 2 shows a simplified block diagram of a music detection module according to one embodiment of the present invention that may be used to implement the music detection module of FIG. 1;

FIG. 3 shows a simplified flow diagram of processing performed by the pause-based music detection module of FIG. 2 according to one embodiment of the present invention;

FIG. 4 shows an exemplary histogram for a hypothetical telephone conversation; and

FIGS. 5A and 5B show pseudocode according to one embodiment of the present invention that may be used to update the energy threshold value in FIG. 3.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

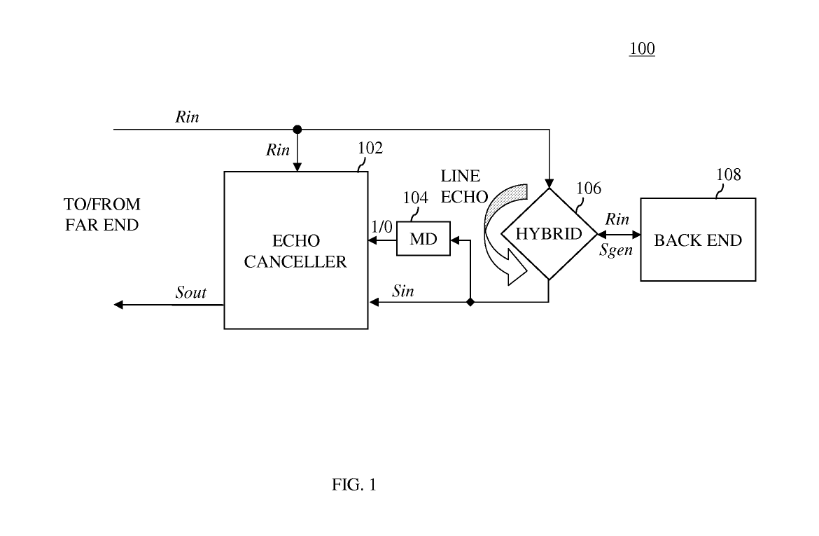

FIG. 1 shows a simplified block diagram of a near end 100 of a public switched telephone network (PSTN) according to one embodiment of the present invention. A first user located at near end 100 communicates with a second user located at a far-end (not shown) of the network. The user at the far end may be, for example, a consumer using a land-line telephone, cell phone, or any other suitable communications device. The user at near end 100 may be, for example, a business that utilizes a music-on-hold system. As depicted in FIG. 1, near end 100 has two communication channels: (1) an upper channel for receiving signal Rᵢₙ generated at the far end of the network and (2) a lower channel for communicating signal Sₒᵤₜ to the far end. The far end may be implemented in a manner similar to that of near end 100, rotated by 180 degrees such that the far end receives signals via the lower channel and communicates signals via the upper channel.

Received signal Rᵢₙ is routed to back end 108 through hybrid 106, which may be implemented as a two-wire-to-four-wire converter that separates the upper and lower channels. Back end 108, which is part of user equipment such as a telephone, may include, among other things, the speaker and microphone of the communications device. Signal S_{gen} generated at the back end 108 is routed through hybrid 106, where unwanted echo may be combined with signal S_{gen} to generate signal Sᵢₙ that has diminished quality. Echo canceller 102 estimates echo in signal Sᵢₙ based on received signal Rᵢₙ and cancels the echo by subtracting the estimated echo from signal Sᵢₙ to generate output signal Sₒᵤₜ which is provided to the far-end.

When music-on-hold is playing at near end 100 and the far-end user is speaking, the resulting signal Sᵢₙ may comprise both music and echo. As described above in the background, in some conventional public switched telephone networks, rather than cancelling the echo, the non-linear processing module of the echo canceller suppresses the echo by clipping the mixed output signal and replaces the echoed sound fragments with comfort noise. To prevent this from occurring, the non-linear processing module of echo canceller 102 is stopped when music is detected by music detection module 104. Music detection module 104, as well as echo canceller 102 and hybrid 106, may be implemented as part of the user equipment or may be implemented in the network by the operator of the public switched telephone network.

Music detection module 104 preferably receives signal Sᵢₙ in digital format, represented as a time-domain sampled signal having a sampling frequency sufficient to represent telephone quality speech (i.e., a frequency≧8 kHz). Further, signal Sᵢₙ is preferably received on a frame-by-frame basis with a constant frame size and a constant frame rate. Typical packet durations in PSTN are 5 ms, 10 ms, 15 ms, etc., and typical frame sizes for 8 kHz speech packets are 40 samples, 80 samples, 120 samples, etc. Music detection module 104 makes determinations as to whether music is or is not present on a frame-by-frame basis. If music is detected in a frame, then music detection module 104 outputs a value of one to echo canceller 102, instructing echo canceller 102 to not operate the non-linear processing module of echo canceller 102. If music is not detected, then music detection module 104 outputs a value of zero to echo canceller 102, instructing echo canceller 102 to operate the non-linear processing module to cancel echo. Note that, according to alternative embodiments, music detection module 104 may output a value of one when music is not detected and a value of zero when music is detected.

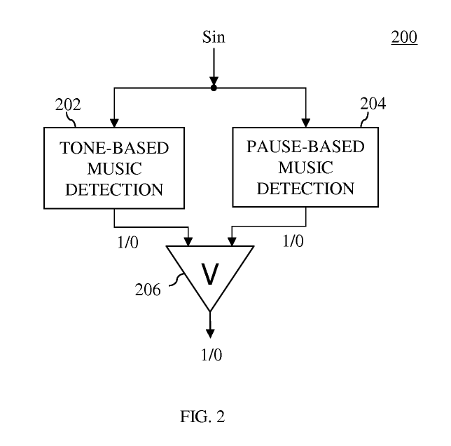

FIG. 2 shows a simplified block diagram of a music detection module 200 according to one embodiment of the present invention that may be used to implement music detection module 104 of FIG. 1. Music detection module 200 has tone-based music detection sub-module 202, pause-based music detection sub-module 204, and Boolean “OR” logic 206. Tone-based music detection sub-module 202 detects the presence of music in received signal Sᵢₙ on a frame-by-frame basis by analyzing tones in received signal Sᵢₙ. Tone-based music detection sub-module 202 may be implemented using any suitable tone-based music detection technique, including those described in the background of this specification and the tone-based music detection technique described in Russian patent application no. ______ filed as Attorney Docket number L09-0669RU1. If tone-based music detection sub-module 202 detects music in a frame, then tone-based music detection sub-module 202 outputs a value of one for that frame. If, on the other hand, tone-based music detection sub-module 202 does not detect music in a frame, then tone-based music detection sub-module 202 outputs a value of zero for that frame.

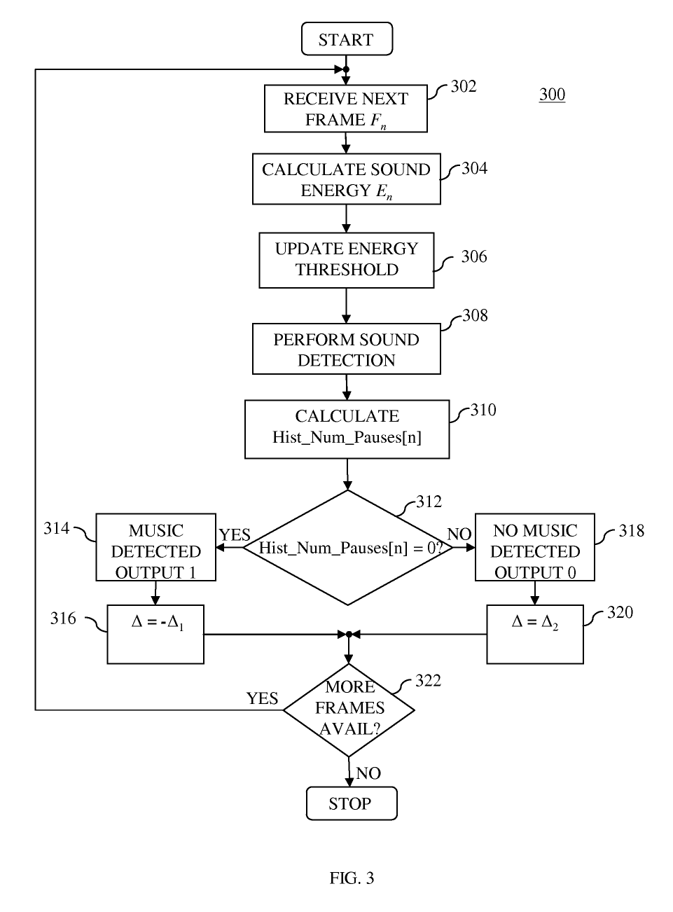

Pause-based music detection sub-module 204, described in further detail below in relation to FIG. 3, determines whether or not music is present in received signal Sᵢₙ on a frame-by-frame basis by analyzing pauses in received signal Sᵢₙ, where a pause corresponds to a cessation of sound (other than the background noise) for a period of time. Typically, human speech contains numerous short pauses ahead of some consonant sounds such as before the letters “P”, “D”, and “T”, and when the speaker is breathing. Music, on the other hand, typically has fewer pauses than speech. Pause-based music detection sub-module 204 detects pauses in received signal Sᵢₙ by comparing the energy of each frame of received signal Sᵢₙ to an energy threshold. The energy threshold approximates the boundary between (i) energy levels that correspond to background noise only and (ii) energy levels that correspond to background noise in addition to other sounds, such as music and speech. If the energy of the frame is less than the energy threshold, then the frame is presumed to correspond to a pause (i.e., a period when no speech or music is present in the received signal Sᵢₙ). If, on the other hand, the energy of the frame is greater than or equal to the energy threshold, then the frame is presumed to correspond to sound due to, for example, speech or music in addition to background noise.

Note that a pause may last an entire frame, less than an entire frame, or multiple frames. Further, the beginning of a pause does not necessarily correspond to the beginning of a frame, and the end of a pause does not necessarily correspond to the end of a frame. Determining that the energy of a frame is less than the energy threshold indicates that the frame is a “pause frame” that either (i) contains one or more pauses or (ii) is part of a pause spanning multiple frames.

A sum of the number of pause frames is computed for a specified number W_{td} of consecutive frames, where the specified number W_{td} includes the current frame and the last (W_{td}−1) frames. If the sum is equal to zero, indicating that there have been no pauses in the most recent W_{td} frames, then it is presumed that the current frame contains music, and pause-based music detection sub-module 204 outputs a value of one for that frame. If, on the other hand, the sum is not equal to zero, then it is presumed that the current frame does not contain music (i.e., corresponds to a pause in speech or a long period of silence), and pause-based music detection sub-module 204 outputs a value of zero for that frame.

The outputs of tone-based music detection sub-module 202 and pause-based music detection sub-module 204 are applied to Boolean “OR” logic 206, which performs logical disjunction on the outputs to generate the final decision as to whether or not music is present in the current frame. When tone-based music detection sub-module 202, pause-based music detection sub-module 204, or both tone-based music detection sub-module 202 and pause-based music detection sub-module 204 output a value of one, Boolean “OR” logic 206 outputs a value of one, indicating that music is present. When both tone-based music detection sub-module 202 and pause-based music detection sub-module 204 output a value of zero, Boolean “OR” logic 206 outputs a value of zero, indicating that music is not present.

FIG. 3 shows a simplified flow diagram 300 of processing performed by pause-based music detection module 204 of FIG. 2 according to one embodiment of the present invention. Upon startup, a data frame Fₙ of signal Sᵢₙ is received in step 302, where the frame index n=0, 1, 2, etc. The energy Eₙ of received data frame Fₙ is calculated in step 304 as the average sample magnitude within the frame as shown in Equation (1) below:

$${E}_{n} = \frac{{\sum }_{i = 1}^{M} \vert {F}_{n} [ i ] \vert}{M} \qquad ( 1 )$$

where Fₙ[i] refers to the i^{th} sample of received data frame Fₙ, and M is the number of samples in frame Fₙ.

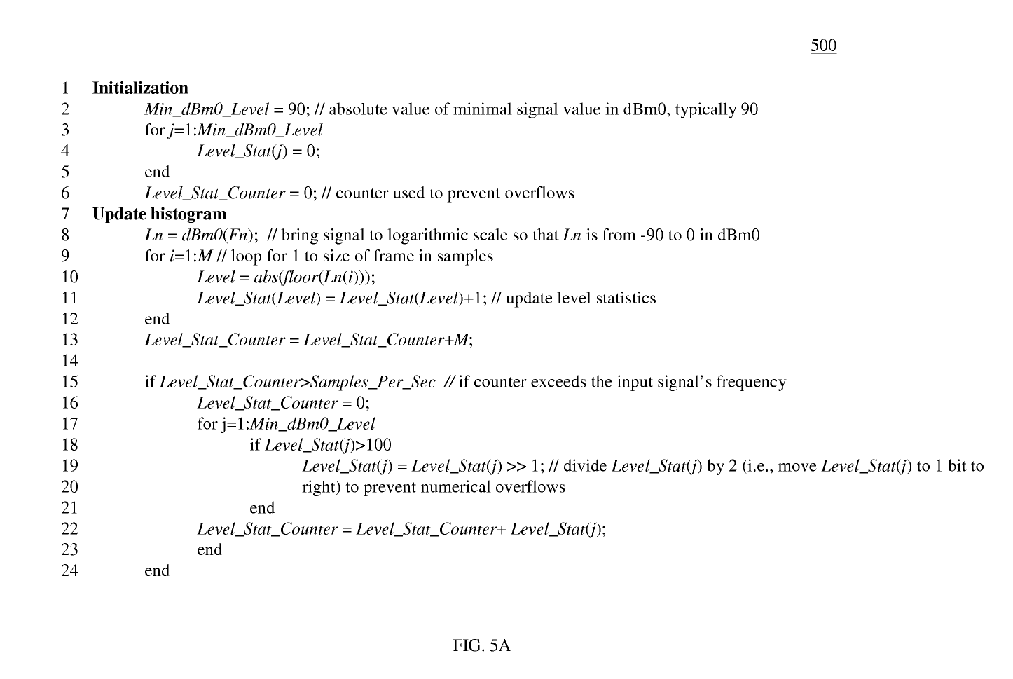

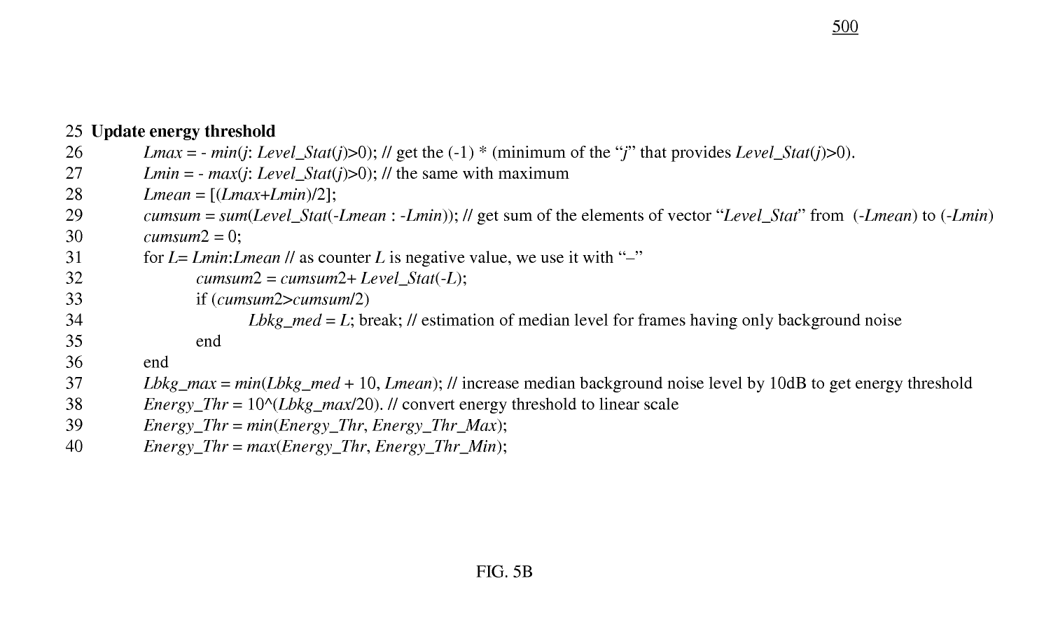

In step 308, the calculated energy Eₙ for frame Fₙ is compared to the sum of (i) an energy threshold value Energy_Thr and (ii) an energy threshold offset value Δ, which is initialized to zero, to determine whether the frame Fₙ contains only background noise or contains sound due to speech or music in addition to background noise. If the calculated energy is less than the sum, then the frame is determined to contain only background noise. Otherwise, the frame is determined to contain sound due to music or speech in addition to the background noise. Energy threshold value Energy_Thr is adaptively updated in step 306, which may be performed before, after, or in parallel with step 304. Energy threshold value Energy_Thr is updated as described in further detail below in relation to FIG. 5 to account for variations in the background noise level that occur over time. Variations in background noise level generally occur during a telephone conversation due to changes in the background environment, such as walking from a quite room to a noisy room.

If calculated energy Eₙ for frame Fₙ is less than the sum of Energy_Thr and Δ (i.e., Eₙ<(Energy_Thr+Δ)), then a pause detection parameter aₙ corresponding to frame Fₙ is set equal to one (i.e., aₙ=1), indicating that frame Fₙ corresponds to a pause (i.e., may be part of a pause or contain a whole pause). If, on the other hand, calculated energy Eₙ is greater than or equal to the sum of Energy_Thr and Δ (i.e., Eₙ≧(Energy_Thr+A)), then pause detection parameter aₙ is set equal to zero (i.e., aₙ=0), indicating that frame Fₙ does not correspond to a pause (i.e., is not part of a pause and does not contain a whole pause).

In step 310, a sum Hist_Num_Pauses[n] of the number of frames in the W_{td} most-recent frames that may be part of a pause is calculated as shown in Equation (2) below:

$$Hist\_Num \_Pauses [ n ] = {\sum }_{k = n - {W}_{td} + 1}^{n} {a}_{k} \qquad ( 2 )$$

where aₖ is the pause detection parameter, k is the frame index, and k=n for the current frame Fₙ. The number W_{td} of frames used in Equation (2) may be determined empirically. For example, in one implementation, W_{td} was determined to be 100. Note that the total delay of pause-based music detection is greater than or equal to W_{td}×M/Samples_Per_Sec, where the constant Samples_Per_Sec is the number of samples per second in the received signal Sᵢₙ, which corresponds to the signal sampling frequency (e.g., 8 kHz).

The sum Hist_Num_Pauses[n] is compared to zero (step 312). If Hist_Num_Pauses[n] is equal to zero, then the current frame Fₙ is presumed to contain music, and a value of one is output (step 314) to, for example, Boolean “OR” logic 206 of FIG. 2. Energy threshold offset value Δ is then set equal to −Δ₁ (step 316), where Δ₁ is a predefined positive constant that may be selected empirically. Constant Δ₁ helps to smooth out the music detection output by making it easier to find that speech is present after music has been found. If, on the other hand, Hist_Num_Pauses[n] is not equal to zero, then the current frame Fₙ is presumed to not correspond to music (i.e., corresponds to a pause in speech or long period of silence), and a value of zero is output (step 318). Energy threshold offset value Δ is then set equal to Δ₂ (step 320), where Δ₂ is another predefined positive constant that may be selected empirically. Constant Δ₂ further helps to smooth out the music detection output by making it more difficult to find that music is present after music has not been found. According to one implementation, −Δ₁ and Δ₂ were determined to be −3 and 7, respectively.

After updating energy threshold offset value Δ, a determination is made in step 322 as to whether or not more frames Fₙ are available for music detection. If more frames Fₙ are available, then processing returns to step 302, and the next frame Fₙ is received. If more frames Fₙ are not available, then music detection is stopped.

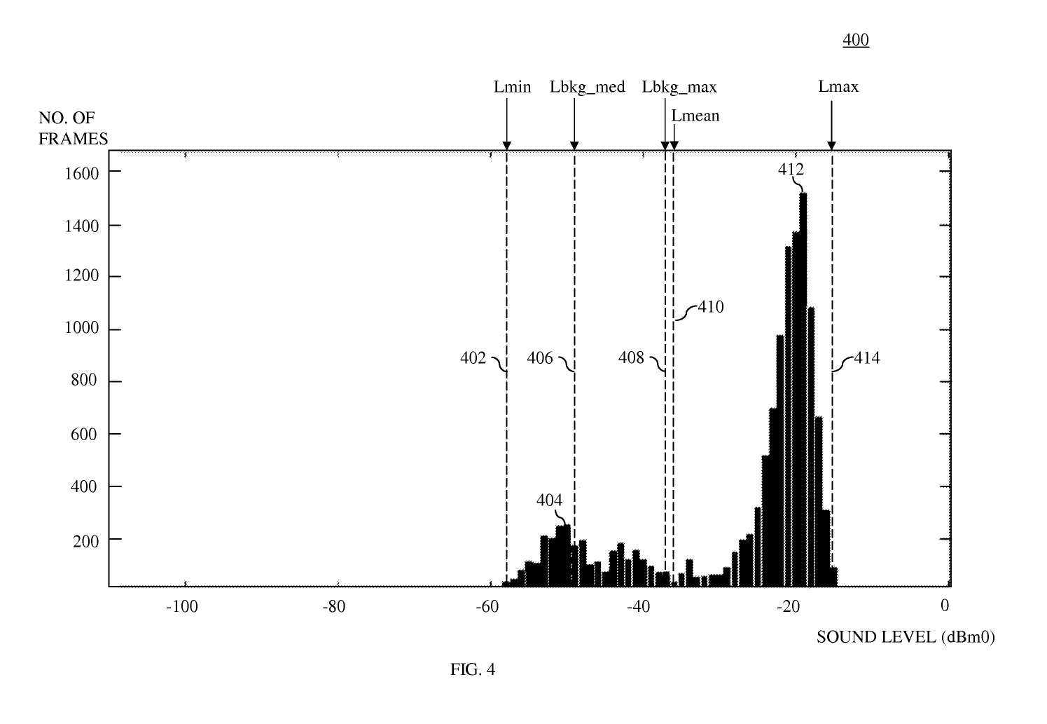

To understand one implementation of processing that may be performed by energy threshold updating step 306, consider FIG. 4. FIG. 4 shows an exemplary histogram 400 for a hypothetical telephone conversation. The sound levels of the conversation per frame in dBm0 are plotted on the x-axis, and the number of frames Fₙ corresponding to each sound level is plotted on the y-axis. Histogram 400 contains two peaks: high peak 412, which corresponds to frames that have speech or music (referred to herein as “speech/music frames”), and low peak 404, which corresponds to the average noise level of frames that have no speech or music (referred to herein as “noise frames”). High peak 412 shows that the greatest number of speech/music frames (i.e., approximately 1500) correspond to a sound level of approximately −18 dBm0. Low peak 404 shows that the greatest number of noise frames (i.e., approximately 250) correspond to a sound level of approximately −50 dBm0.

Five dashed lines are shown on histogram to highlight sound levels of interest that are used in determining the energy threshold value Energy_Thr. Dashed line 402 corresponds to the minimum sound level Lmin of the conversation, which dashed line 406 corresponds to the median background noise level Lbkg_med of the conversation, dashed line 408 corresponds to the maximum background noise level Lbkg_max of the conversation, dashed line 410 corresponds to the mean background noise level Lmean, and dashed line 414 corresponds to the maximum sound level Lmax of the conversation. The relevance of these dashed lines is discussed in further detail below in relation to FIG. 5.

FIGS. 5A and 5B show pseudocode 500 according to one embodiment of the present invention that may be used to adaptively update the energy threshold value Energy_Thr in FIG. 3. In general, pseudocode 500 generates a histogram, similar to that of histogram 400, based on the received frames Fₙ of signal Sᵢₙ. Using the generated histogram, pseudocode 500 determines (i) the minimum sound level Lmin corresponding to dashed line 402 and (ii) the maximum sound level Lmax corresponding to dashed line 414, and calculates, based on the minimum sound level Lmin and maximum sound level Lmax, the mean sound level Lmean corresponding to line 410. Based on the minimum sound level Lmin and the mean sound level Lmean, pseudocode 500 estimates the median background noise level Lbkg_med (i.e., the median sound level of frames containing only background noise) corresponding to dashed line 406. Based on the median background noise level Lbkg_med, pseudocode 500 estimates the maximum background noise level Lbkg_max, where the maximum background noise level Lbkg_max approximates the boundary between (i) energy levels that correspond to background noise only and (ii) energy levels that correspond to background noise in addition to other sounds, such as music and speech. The maximum background noise level Lbkg_max is then converted into linear scale and bounded by minimum and maximum threshold values to generate the energy threshold Energy_Thr.

Pseudocode 500 generates a number of bins j, where each bin j has a width of 1 dBm0. The bin levels j range from 1 to a parameter Min_dBm0_Level that is initialized to 90 in line 2 of pseudocode 500. Thus, the number of bins generated by pseudocode 500 is equal to Min_dBm0_Level (i.e., 90). Each bin j corresponds to a sound level −j dBm0 on the x-axis of the histogram. Further, each bin j corresponds to a bin level Level_Stat(j) that is initialized to zero in lines 3 to 5, where Level_Stat(j) represents the number of frames having a sound level −j dBm0 on the x-axis of the histogram. Thus, Level_Stat(1) is the level of bin j=1 corresponding to frames having the highest sound level (i.e., from 0 dBm0 to −1 dBm0), while Level_Stat(Min_dBm0_Level) is the level of bin j=Min_dBm0_Level corresponding to frames having the lowest sound level (i.e., from (−Min_dBm0_Level+1) dBm0 to −Min_dBm0_Level dBm0).] In line 6, a counter Level_Stat_Counter(j), which is used to prevent numerical overflows in the histogram as described below, is initialized to zero.

In lines 7 to 25 of pseudocode 500 in FIG. 5A, the histogram is updated based on the samples Fₙ[i] of the received frame, where i=1, . . . , M. In particular, in line 8, the received frame Fₙ is converted into dBm0 units, where function dBm0(x) is implemented as follows:

dBm0(x)=max(−90,6.02×log₂(x/16020.0)) (3)

In lines 9 to 11, the bin levels Level_Stat(j) of the histogram are updated. For each sample Fₙ[i] of the received frame Fₙ, an absolute sound level value Level is determined in line 10. The bin level Level_Stat(j) corresponding to the absolute sound level value Level is then increased by one in line 11. Each bin level Level_Stat(j) is a counter for a bin j that is increased each time a sample Fₙ[i] of the signal Sᵢₙ that has the corresponding absolute sound level Level is received. For example, suppose that a sample Fₙ[i] has a sound level of −40 dBm0. In that case, in line 10, the absolute sound level value Level is determined to be 40. In line 11, the bin level Level_Stat (j) corresponding to an absolute sound level value Level of 40 (i.e., Level_Stat (40)) is increased by one.

After all of the samples Fₙ[i] of the received frame Fₙ have been used to update the bin levels Level_Stat(j), Level_Stat_Counter is increased by M as shown in line 13. Level_Stat_Counter tracks the sum of all bin levels Level_Stat(j) (i.e., the amount of processed statistics).

As more frames Fₙ are received, bin levels Level_Stat(j) become large. To prevent numerical overflows of bin levels Level_Stat(j), bin levels Level_Stat(j) are adjusted in lines 15 to 24 when Level_Stat_Counter becomes larger than Samples_Per_Second (i.e., the number of input signal samples received per second). As shown in lines 15 and 16, if Level_Stat_Counter is larger than Samples_Per_Second, then Level_Stat_Counter is reset to zero. The bin levels Level_Stat(j) are then compared to a value of 100, and the binary representation of each bin level Level_Stat(j) that is greater than 100 is shifted one bit to the right as shown in lines 17 to 20. Shifting a bin level Level_Stat(j) one bit to the right is equivalent to dividing the bin level Level_Stat(j) by a value of two. Note that, according to alternative embodiments of the present invention, all bin levels Level_Stat(j) may be divided by two. Upon considering each bin level Level_Stat(j), Level_Stat_Counter is updated to reflect the new Level_Stat(j) value as shown in line 22. Once all sound levels j have been considered, the value of Level_Stat_Counter is equal to the sum of all bin levels Level_Stat(j).

In lines 25 to 40 of pseudocode 500 in FIG. 5B, the energy threshold Energy_Thr is updated based on the generated histogram. In line 26, the maximum sound level Lmax is determined by finding the lowest bin j for which the corresponding bin level Level_Stat(j) is greater than zero, and multiplying the resulting bin j by negative one. The maximum sound level Lmax corresponds to dashed line 414 in exemplary histogram 400 in FIG. 4. In line 27, the minimum sound level Lmin is determined by finding the highest bin j for which the corresponding bin level Level_Stat(j) is greater than zero, and multiplying the resulting bin j by negative one. The minimum sound level Lmin corresponds to dashed line 402 in exemplary histogram 400 in FIG. 4.

After generating Lmax and Lmin, a mean sound level Lmean is calculated as shown in line 28, and a sum cumsum of all bin levels Level_Stat(j) corresponding to bins −Lmean to −Lmin is calculated as shown in line 29. In lines 31 to 36, the sound level Lbkg_med corresponding to the median sound level between Lmin and Lmean is determined. This is accomplished by incrementally summing the bin levels Level_Stat(j) starting from sound level Lmin until the resulting sum cumsum2 is greater than half of cumsum. The median sound level Lbkg_med corresponds to dashed line 406 in exemplary histogram 400 in FIG. 4.

In line 37, sound level Lbkg_max, which approximates the boundary between (i) energy levels that correspond to background noise only and (ii) energy levels that correspond to background noise in addition to other sounds, such as music and speech, is determined Sound level Lbkg_max corresponds to dashed line 408 in exemplary histogram 400 in FIG. 4 and is set to be the smaller of (i) the sound level Lbkg_med increased by 10 dBm0 and (ii) Lmean. Note that, according to alternative embodiments of the present invention, values other than 10 dBm0 may be used. In line 38, the energy threshold Energy_Thr is calculated by converting the value of sound level Lbkg_max from the dBm0 logarithmic scale into the linear scale. The energy threshold Energy_Thr is then bounded by a specified maximum threshold value Energy_Thr_Max in line 39 and a specified minimum threshold value Energy_Thr_Min in line 40. Maximum threshold value Energy_Thr_Max and minimum threshold value Energy_Thr_Min are predefined constants that may be determined empirically. For example, in one implementation, Energy_Thr_Max and Energy_Thr_Min were determined to be −35 and −55 decibels, respectively.

Pause-based music detection sub-modules of the present invention are relatively low in complexity compared to tone-based music detection sub-modules. When implemented together with a tone-based music detection sub-module as shown in FIG. 2, a paused-based music detection sub-module of the present invention constitutes a low-complexity add-on that does not significantly increase the overall latency of music detection. Pause-based music detection sub-modules of the present invention enhance the overall music detection quality by reducing the likelihood of false negative music detection (i.e., increases the likelihood that music will be accurately detected when the tone-based music detection sub-module determines that frames with music do not have music).

According to alternative embodiments of the present invention, Boolean Logic other than Boolean “OR” logic may be used with tone-based and pause-based music detection sub-modules. For example, if the tone-based music detection sub-module is prone to false positive music detection (i.e., determining that frames without music do have music), then Boolean “OR” logic may be replaced with Boolean “AND” logic. Boolean “AND” logic requires the outputs of both music detection sub-modules to be one before module 200 outputs a one.

According to further embodiments of the present invention, pause-based music detection sub-module 204, tone-based music detection sub-module 202, both the pause-based and tone-based music detection sub-modules, or music detection module 200 may require their processing to indicate the presence or absence of music for a specified number of consecutive frames, or for a specified percentage of frames during the previous specified number of frames (e.g., 80% of the last ten frames) before they output a one.

According to yet further embodiments of the present invention, music detection module 104 of FIG. 1 may be implemented using pause-based music sub-module 204 of FIG. 2, without tone-based music detection sub-module 202 and Boolean “OR” logic 206.

Although the present invention was described relative to its use with public switched telephone networks, the present invention is not so limited. The present invention may be used in suitable applications other than public switched telephone networks.

Energy threshold updating step 306 and sound detection step 308 of FIG. 3 together may be considered to be a type of voice activity detection algorithm. Voice activity detection algorithms differentiate between (i) pauses in an audio signal and (ii) non-pauses in an audio signal, such as voice or music. According to alternative embodiments of the present invention, energy threshold updating step 306 and sound detection step 308 may be implemented using any suitable voice activity detection algorithm, including those that do not employ the energy threshold updating of pseudocode 500 in FIG. 5.

According to alternative embodiments of the present invention, the energy threshold value Energy_Thr updating in step 306 may be omitted to decrease computational complexity of flow diagram 300 or for other reasons. In such embodiments, energy threshold value Energy_Thr may be fixed to a predefined value that sufficiently estimates the noise level for most real-world scenarios.

The complexity of the processing performed in flow diagram 300 of FIG. 3 may be estimated in terms of integer multiplications and summations per second. The sound energy calculation step 304 performs approximately 2M summations. The sound detection step 308 performs one summation. The calculation of Hist_Num_Pauses[n] 310 performs two summations when implemented as shown in which Equation (4) below:

Hist_Num_Pauses[k]=Hist_Num_Pauses[n−1]+a[n]−a[n−W_{td}] (4)

The energy threshold updating step 306, as implemented in pseudocode 500 of FIG. 5 performs a histogram update for each frame received, which uses M logarithmic operations for converting the frame to dBm0, 2M multiplications and 2M summations, and updates the energy threshold Energy_Thr, which uses 4M+1 summations and one exponent calculation.

In embodiments of the present invention that use a fixed energy threshold Energy_Thr value, the complexity is approximately 2M+3 summations per frame Fₙ. For a typical frame size of M=40 (5 ms frame for 8 kHz signal), the complexity is approximately 16,600 summations per second. To implement the logarithmic operations in pseudocode 500, a look-up table may be used. In one implementation of a look-up table method described in scheme 2 of M. Zhang, et al., “Table-Driven Newton Scheme for High Precision Logarithmic Generation,” IEEE Proc.-Comput. Digital Tech., Vol. 141, #5, September 1994, the teachings of which are incorporated herein by reference in their entirety, logarithmic operations are performed using 7 multiplications and 2 summations. For a typical frame size of M=40, the complexity of pseudocode 500 is approximately 16,600 summations plus an additional 104,000 arithmetic operations per second. Thus, in embodiments of the present invention that update energy threshold Energy_Thr as shown in pseudocode 500 of FIG. 5, the complexity is approximately 120,600 arithmetic operations per second for a frame size of M=40.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values stored in a non-transitory recording medium generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A processor-implemented method for processing audio signals to determine whether or not the audio signals correspond to music, the method comprising:
(a) the processor characterizing whether pauses exist in a received audio signal (e.g., Sin); and
(b) the processor making a pause-based determination of whether or not the received audio signal corresponds to music based on the characterization of whether pauses exist in the received audio signal.

2. The processor-implemented method of claim 1, wherein:
step (a) comprises the processor determining whether one or more pauses exist in a window of the received signal; and
step (b) comprises the processor making the pause-based determination that the window does not correspond to music if the processor determines that the window comprises one or more pauses.

3. The processor-implemented method of claim 2, wherein:
the window comprises a plurality of frames;
step (a) comprises, for each frame in the window:
(a1) the processor characterizing energy level of the frame;
(a2) the processor comparing the energy level of the frame to a specified energy threshold value (e.g., Energy_Thr+delta);
(a3) the processor determining that the frame corresponds to a pause, if the processor determines that the energy level of the frame is less than the specified energy threshold value; and
step (b) comprises the processor making the pause-based determination that the window does not correspond to music if the processor determines that any frame in the window corresponds to a pause.

4. The processor-implemented method of claim 3, wherein the specified energy threshold value for a current frame depends on whether or not the processor made the pause-based determination that a previous window corresponds to music.

5. The processor-implemented method of claim 4, wherein, when the processor makes the pause-based determination that the previous window corresponds to music, the specified energy threshold value is smaller than the specified energy threshold value when the processor makes the pause-based determination that the previous window corresponds to music.

6. The processor-implemented method of claim 3, wherein the processor adaptively updates the specified energy threshold value based on the energy levels of the frames.

7. The processor-implemented method of claim 1, wherein:
the processor comprises a pause-based music detection sub-module that performs steps (a) and (b) for user equipment (e.g., 100) further comprising an echo canceller (e.g., 102) adapted to cancel echo in the received audio signal to generate an outgoing audio signal (e.g., Sout) for the user equipment; and
processing of the received audio signal by the echo canceller is based on whether the pause-based music detection sub-module determines that the received audio signal corresponds to music.

8. The processor-implemented method of claim 1, wherein the processor comprises:
a pause-based music detection sub-module (e.g., 204) that performs steps (a) and (b) for user equipment (e.g., 100);
a tone-based music detection sub-module (e.g., 202) that makes a tone-based determination whether or not the received audio signal corresponds to music based on a characterization of tones in the received audio signal; and
a logic sub-module (e.g., 206) that combines the pause-based determination and the tone-based determination to determine whether or not the received audio signal corresponds to music.

9. The processor-implemented method of claim 8, wherein the logic module applies a logical OR operation to the pause-based determination and the tone-based determination.

10. Apparatus comprising a processor for processing audio signals to determine whether or not the audio signals correspond to music, wherein:
the processor is adapted to characterize whether pauses exist in a received audio signal; and
the processor is adapted to make a pause-based determination of whether or not the received audio signal corresponds to music based on the characterization of whether pauses exist in the received audio signal.

11. The apparatus of claim 10, wherein:
the processor is adapted to determine whether one or more pauses exist in a window of the received signal; and
the processor is adapted to make the pause-based determination that the window does not correspond to music if the processor determines that the window comprises one or more pauses.

12. The apparatus of claim 11, wherein:
the window comprises a plurality of frames;
for each frame in the window:
the processor is adapted to characterize energy level of the frame;
the processor is adapted to compare the energy level of the frame to a specified energy threshold value (e.g., Energy_Thr+delta); and
the processor is adapted to determine that the frame corresponds to a pause, if the processor determines that the energy level of the frame is less than the specified energy threshold value; and
the processor is adapted to make the pause-based determination that the window does not correspond to music if the processor determines that any frame in the window corresponds to a pause.

13. The apparatus of claim 12, wherein the specified energy threshold value for a current frame depends on whether or not the processor made the pause-based determination that a previous window corresponds to music.

14. The apparatus of claim 13, wherein, when the processor makes the pause-based determination that the previous window corresponds to music, the specified energy threshold value is smaller than the specified energy threshold value when the processor makes the pause-based determination that the previous window corresponds to music.

15. The apparatus of claim 12, wherein the processor adaptively updates the specified energy threshold value based on the energy levels of the frames.

16. The apparatus of claim 10, wherein:
the processor comprises a pause-based music detection sub-module that is adapted to make the pause-based determination for user equipment (e.g., 100) further comprising an echo canceller (e.g., 102) adapted to cancel echo in the received audio signal to generate an outgoing audio signal (e.g., Sout) for the user equipment; and
processing of the received audio signal by the echo canceller is based on whether the pause-based music detection sub-module determines that the received audio signal corresponds to music.

17. The apparatus of claim 10, wherein the processor comprises:
a pause-based music detection sub-module (e.g., 204) that is adapted to make the pause-based determination for user equipment (e.g., 100);
a tone-based music detection sub-module (e.g., 202) that makes a tone-based determination whether or not the received audio signal corresponds to music based on a characterization of tones in the received audio signal; and
a logic sub-module (e.g., 206) that combines the pause-based determination and the tone-based determination to determine whether or not the received audio signal corresponds to music.

18. The apparatus of claim 17, wherein the logic module applies a logical OR operation to the pause-based determination and the tone-based determination.

19. The apparatus of claim 10, wherein the apparatus is an integrated circuit.
